(19) United States
(12) Patent Application Publication
(10) Pub. No.: US 2002/0142738 A1
(43) Pub. Date: Oct. 3, 2002

(54) Telephone comprising a perfected control keypad

(76) Inventors: Pascal Jambie, Paris (FR); Jean-Pierre Lubowicki, Le Mans (FR); Bertrand Richez, Paris (FR)

Correspondence Address: PHILIPS ELECTRONICS NORTH AMERICAN CORP, 580 WHITE PLAINS RD, TARRYTOWN, NY, 10591, US

(21) Appl. No.: 10/106,948

(22) Filed: Mar. 26, 2002

(30) Foreign Application Priority Data
Mar. 27, 2001 (FR) 0104107

(51) Int. Cl. H04B 1/38

(52) U.S. Cl. 455/90; 455/575

(57) ABSTRACT

The invention proposes a telephone (10), notably of the GSM type, which has a control device, consisting notably of a keypad (24) with keys (22) able to move overall vertically in an independent manner between an idle position and an actuation position, the individual actuation of which makes it possible to key in a combination of alphanumeric characters, notably a telephone number and a control device for controlling the movement of a cursor (36), or the scrolling of a menu on a display screen (32), characterized in that at least one of said dialing keys (22) is a multifunction key (40, 42, 44, 46) whose actuation according to a first mode makes it possible to dial, and whose actuation according to a second mode makes it possible to control the movement of the cursor (36).

The invention proposes a telephone, notably a portable telephone of the GSM type, which has an improved control keypad.

The invention proposes more particularly a telephone which has a keypad, a display device and a device for controlling the movement of a cursor on the display device.

In general terms telephones of the mobile type consist of a casing in which there are notably arranged a keypad, a cursor movement control device and a display device.

The keys, also referred to as keypad push buttons, are able overall to move vertically between an upper idle position and a pressed-in actuation position.

Each key has a top actuation part to which it is possible to apply an actuation and control force, and a rigid lower part which is able to cooperate with a member for triggering an associated switch.

When a key is in the actuation position, the switch associated with it makes it possible to modify the electrical state of a control circuit, notably of the circuit controlling the display device in order to move a cursor on the display device and/or to scroll down a menu.

In general terms, the keypads pass through the front, or main, face of the casing so that their upper actuation parts are accessible to the user.

The display device supplies alphanumeric information, which may be very varied, such as figures or letters but also pictograms, designs or images.

Mobile telephone display devices frequently have pictograms or characters, which may be figures and/or letters, distributed over several display rows and columns and which can represent the wording of a function of the telephone.

Mobile telephones have to have more and more functions. In order to manage them, it is known that use can be made of menus of the pull-down type, whose complexity increases with the number of functions. The simplicity and speed of selection of the desired function is then an important characteristic of the ergonomics of the appliance.

It is then necessary to be able to move a cursor quickly and easily on the display device so as to be able to position it on each of the characters, or on or opposite the wording of a function.

The movement of the cursor is also referred to as “navigation” of the cursor on the display device.

These movements are normally obtained by means of a dedicated control device which can consist of one or more keys which cooperate with associated electrical switches and which modify the display device control circuit in order to control the movement of the cursor.

It is also known that a key can be associated with each direction of movement in two orthogonal directions of the display device.

The movement keys can be additional keys on the keypad, or keys adjacent to a standard alphanumeric keypad, which results in an increase in the dimensions of the keypad and consequently of the telephone, which goes counter to the miniaturization being sought for this type of appliance, having regard to the fact that there is a minimum size for each key.

In addition, so as to improve the user friendliness of the appliance and increase the number of items of information presented to the user, it is advantageous to use a display device which is as large as possible, without increasing the dimensions of the telephone. It is thus necessary to reduce the size of the keypad.

Consequently, the solution which consists of associating an additional dedicated key with each direction of movement of the cursor is not an advantage.

The dedicated device for controlling the movement of the cursor can also consist of a navigation “wheel”. The movement of the cursor is then proportional to the rotation of the wheel.

When the electronic appliance is a mobile telephone, for example of the GSM type, the wheel is advantageously arranged in a side wall of the telephone so as to facilitate its use. However, navigation wheels require a dedicated sensor which supplies information representing the rotation of the wheel to the circuit controlling the display device. In addition, it is necessary to provide an additional opening in the casing so that the wheel is accessible from the outside.

The dedicated sensor with multiple switches, and the production of the additional opening, increases the cost of manufacturing the electronic appliance concerned. In addition, the use of a wheel generally allows the movement of the cursor along only one axis, in both directions.

The dedicated movement control device can also consist of a pointing device, also referred to as a “trackball” or joystick.

Such a pointing device consists of a lever (joystick) or a ball (trackball). The cursor moves on the screen according to the movement or rotation and the axis and direction of movement or rotation applied to the lever or ball respectively.

In a similar manner to the use of a wheel, the pointing device requires an expensive dedicated sensor.

So as to provide a solution to this problem, the invention proposes a telephone, notably of the GSM type, which has a control device consisting notably of a keypad with keys able to move overall vertically in an independent fashion between an idle position and an actuation position, the individual actuation of which makes it possible to key in a combination of alphanumeric characters, notably a telephone number and a device for controlling the movement of a cursor, or the scrolling of a menu on a display screen,

characterized in that at least one of said dialing keys is a multifunction key whose actuation according to a first mode makes it possible to dial, and whose actuation according to a second mode makes it possible to control the movement of the cursor.

According to other characteristics of the invention:

the keypad has at least one pair of associated multifunction keys which makes it possible to control, respectively in two opposite directions, the movement of the cursor along an axis substantially parallel to that of the alignment of the two keys in this pair;

the keypad has two pairs of associated multifunction keys which are arranged so that the direction of alignment of the two keys in the first pair is substantially at right angles to the direction of alignment of the two keys in the second pair;

the four multifunction keys in the two pairs are keys for dialing even digits on a standard 10-digit dialing keypad;

the four multifunction keys in the two pairs are connected together so as to form a star with four arms, each end of which constitutes a key;

the keypad has at least a fifth multifunction key whose actuation according to a first mode makes it possible to dial, and whose actuation according to a second mode makes it possible to demand the validation of an instruction;

the fifth key is arranged substantially at the intersection of the axes of the alignments of the two pairs of keys;

the center of the star has a central hole for the fifth key to pass with a view to allowing the independent actuation of the star and the fifth key;

the telephone has means of controlling the simultaneous switching of the change in actuation mode of said multifunction keys; the means of controlling the switching from one mode to another consist of the recognition of a predetermined voice message by the control device;

the means of controlling the switching from one mode to another consist of the holding of a key of the control keypad in the actuation position for a period greater than a predetermined period;

the means of controlling the switching from one mode to another consist of the actuation of certain keys on the keypad in a predetermined order;

the means of controlling the switching from one mode to another consist of the actuation of a specific key on the keypad.

The invention is also related to any apparatus having a key pad.

The invention will be further described with reference to examples of embodiments shown in the drawings to which, however, the invention is not restricted:

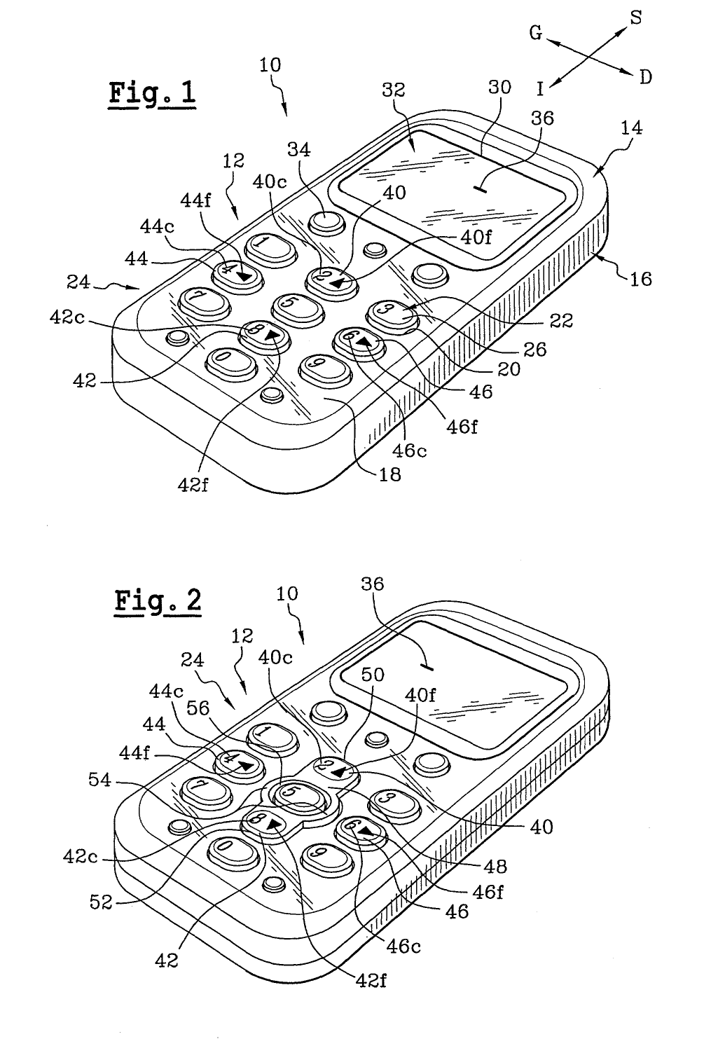

FIG. 1 is a perspective view of a mobile telephone according to a first embodiment of the invention;

FIG. 2 is a perspective view of a mobile telephone according to a second embodiment of the invention;

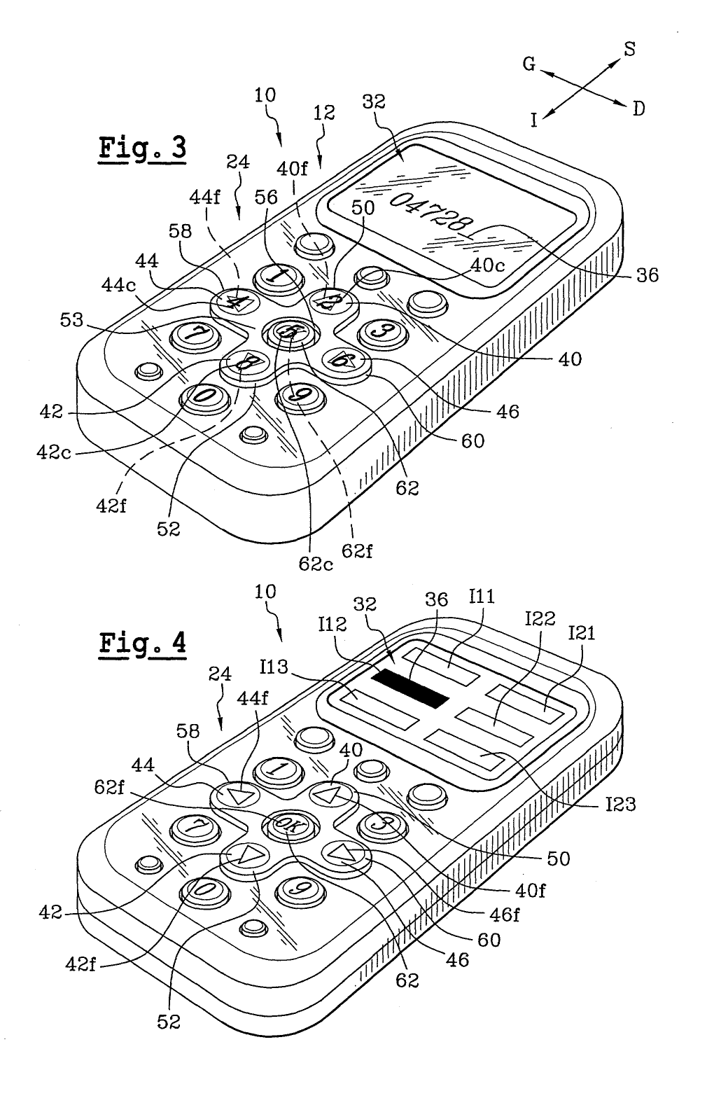

FIG. 3 is a perspective view of a mobile telephone according to a third embodiment of the invention, which depicts the telephone in operation according to a first mode of actuation of multifunction keys on the keypad;

FIG. 4 is a perspective view of a mobile telephone according to a third embodiment of the invention, which depicts the telephone in operation according to a second mode of actuating multifunction keys on the keypad.

So as to facilitate an understanding of the description, use will be made hereinafter of an orientation upper, lower and right to left in accordance with the reference frame (S, I, D, G) depicted in FIGS. 1 and 2 and with the orientation of the Figures.

FIG. 1 depicts a mobile telephone 10, which can for example be of the GSM type.

The telephone 10 has a casing 12 consisting of an upper shell 14 and a lower shell 16.

The upper face 18, or front face, of the upper shell 14 has orifices 20 which allow the passage of keys 22 on a standard numeric keypad 24 with ten keys for the telephone 10. The keys 22 are able to move vertically between a top idle position and a pressed-in actuation position in which each cooperates with a device for triggering an associated electrical switch (not shown).

The keypad 24 here consists of ten keys 22 distributed in three horizontal series each of three keys and a tenth key situated in a central zone below the lower series.

The telephone 10 has other additional keys arranged around the standard numeric keypad 24.

The keys 22 consist principally of an upper actuation part 26 to which the finger of a user can apply an actuation or control force. The upper part 26 forms the back of the corresponding key.

The backs of the keys 22 in the three horizontal series of the standard alphanumeric keypad 24 bear the FIGS. 1 to 9. The back of the tenth lower central key bears the FIG. 0.

The keys 22 also consist of a lower rigid actuation part which is able to cooperate with the associated electrical switch triggering device, which is for example an elastically deformable dome.

When the key 22 is in the actuation position, the lower part deforms the dome and modifies the electrical state of the associated electrical control circuit so as to control a function of the electronic appliance 10.

Thus the actuation of an additional key 34 situated in the upper shell 14 above the keypad 24 can make it possible to seize the telephone line.

The upper shell 14 of the casing 12 of the electronic appliance 10 also has a window 30 through which a display device or screen 32 passes, such as a liquid crystal display screen, which is here substantially rectangular.

Actuating the keys 22 on the standard keypad 24 makes it possible to dial a combination of alphanumeric characters, notably a telephone number, and to display it on the screen 32.

Actuating another key on the keypad 24 can also make it possible to move the cursor 34 on the display screen 32 or to validate a selection made or an operation performed previously.

According to the invention, so as to minimize the total number of keys 22 on the telephone 10 while allowing simple and rapid use of the telephone 10, some keys on the standard keypad 24 are multifunction. That is to say actuating them according to a first mode makes it possible to use them in a “conventional” manner for dialing a combination of alphanumeric characters, and actuating them in a second mode makes it possible to control the movements of the cursor 36 on the display screen 32.

Here, in accordance with the Figures, the telephone 10 has four multifunction keys referenced 40, 42, 44 and 46 so as to allow the navigation of the cursor 36 in four directions upwards, downwards, to the left and to the right of the display screen 32 respectively. These four keys correspond to the keys for dialing the digits 2, 8, 4 and 6 respectively.

The invention also proposes that the telephone 10 should have means of controlling the simultaneous switching of the change in actuation mode of all the multifunction keys 40 to 46.

Several solutions can then be envisaged. By way of non-limitative example, the switching means can consist of the actuation of a dedicated key on the telephone 10. However, such a dedicated key requires a substantial increase in the size of the keypad.

Another solution consists of holding a key 22 on the keypad 24 in actuation position for a prolonged period greater than a predetermined period allowing alphanumeric dialing.

This is because, in general, when the user wishes to dial a telephone number, to off-hook or on-hook the line, to select a function etc, the average duration of actuation of the key is less than a first duration. The determination of the first duration can be obtained by statistical studies or by learning.

Consequently, the prolonged holding of a key 22 in the actuation position for a period greater than the first period can mean that the user does not wish to perform the dialing function associated with this key. So as to limit the possibility of an error, that is to say changing mode whereas the user simply wishes to perform the main dialing function associated with the key actuated, it is advantageous for the predetermined period to correspond to a second period greater than the first period. The second period can for example correspond to twice the first period.

The means of switching from one mode to the other can consist of the actuation, in a predetermined order, of certain keys 22 on the keypad 24.

For example, in order to switch from the first to the second mode the user must successively actuate the three keys 22 in the lower horizontal series of the keypad 24.

In order to switch from the second to the first mode he can repeat the same operation. According to a variant, the user can also press successively on another given series of keys.

For this solution, it is necessary to ensure that the actuation of certain keys 22 on the keypad 24 in the predetermined order does not control the actions related to each key 22 actuated separately.

The means of switching from one mode to the other can also consist of the recognition, via the control device, of a predetermined voice message.

Some telephones are equipped with a voice recognition device. Thus the sending by the user of a message such as “change mode” can cause the change in mode. It is also possible for the user to personalize his telephone and to choose a particular message allowing switching from one mode to the other.

So as to facilitate visual recognition and the use of the multifunction keys 40 to 46, the upper wall of their actuation part 26 has a transparent zone which depicts their associated FIGS. 40c to 46c during operation according to the first dialing mode and a pictogram 40f to 46f in the form of an arrow oriented in the direction and axis of movement of the cursor 36, when each of them is actuated according to the second navigation mode.

In a known manner, the keys 22 on the keypad 24 are illuminated from the inside of the casing by a device which is not shown. So that the user immediately knows in which actuation mode he is, it is possible for the illumination device to illuminate only the figures, notably 40c to 46c, or the arrows 40f to 46f depending on whether the first or second mode of actuating the keys is selected.

Thus, when the first actuation mode is selected, the user sees the dialing figures from “0” to “9” and/or the standard triplets of letters associated with these figures, while the four arrows 40f to 46f of the multifunction keys 40 to 46 are invisible since no light is passing through the zone of the upper actuation area on which they are depicted.

In a similar fashion, when the second actuation mode is selected, the user sees only the four arrows 40f to 46f of the multifunction keys 40 to 46.

According to a second embodiment of the invention, depicted in FIG. 2, the keypad 24 has a pair of associated multifunction keys 40, 42.

The pair of associated multifunction keys 40, 42 makes it possible to control the movement of the cursor 36 in two opposite directions, here upwards and downwards on the display screen 32 respectively.

The pair of associated multifunction keys 40, 42 consists here of an elongate element 48, of vertical orientation I-S, which is mounted so as to be articulated overall in its central part about a horizontal axis A1.

In accordance with FIG. 2, the elongate element 48 consists of two arms 50 and 52, each end of which constitutes a key 40 and 42 respectively. The central part 54 for connection of the two arms has a central hole 56 for passage of the key 22 which allows dialing of the figure “5”.

The tilting of the elongate element 48 about the axis A1 allows the mobility of the multifunction keys 40 and 42 so that, in the actuation position, they cooperate with the devices for triggering the associated electrical switches in order to dial a figure or to move the cursor 36 in the first or second selected mode of actuation of the multifunction keys 40 to 46.

When the multifunction keys are used according to the second actuation mode, the use of the elongate element 48 is intuitive. This is because the movement of the finger of the user upwards in the direction of the key 40, or downwards in the direction of the key 42, allows the movement of the cursor 46 on the screen 32 in the same direction.

According to a third preferred embodiment of the invention, the keypad 24 on the telephone 10 has two pairs of associated multifunction keys which are arranged so that the direction of the alignment from top to bottom of the two keys 40 and 42 in the first pair is substantially perpendicular to the direction from right to left of the alignment of the two keys 44 and 46 in the second pair.

The telephone 10 has here a standard keypad 24 for dialing 10 digits. Thus the four multifunction keys 40 to 46 in the two pairs are the keys for dialing the even figures “2”, “8” and “4”, “6”.

In accordance with FIG. 3, the four multifunction keys 40 to 46 in the two pairs are connected together so as to form a single key 53 in a star with four arms 50, 52, 58 and 60, each end of which constitutes a multifunction key 40 to 46 respectively.

The keypad 24 on the telephone 10 advantageously has a fifth multifunction key 62, the actuation of which in the first mode dials an alphanumeric character, and the actuation of which in the second mode controls the validation of an instruction.

Here the fifth multifunction key 62 corresponds to the key 22 which allows the dialing of the figure “5” when the first dialing mode is selected. It is arranged at the intersection of the directions of the alignments from top to bottom and right to left of the two pairs of keys and projects through a hole 56.

Here the center of the star has a central hole 56 for the fifth key 62 to pass with a view to allowing the independent actuation of the star-shaped key 53 and of the fifth key 62.

So as to indicate to the user that the fifth multifunction key 62 validates an instruction, an inscription “OK” appears on its back when it is functioning in the second actuation mode.

The fifth multifunction key 62 can also be produced in a single piece with the star-shaped key 53. In this case, actuation of the central part of the key 53 triggers the electrical switch associated with the fifth multifunction key 62 in order to control the validation of an instruction.

FIGS. 3 to 4 depict the telephone 10 in the two modes of actuating the multifunction keys 40 to 46 and 62. The telephone 10 is here equipped with a device for illuminating the keys which illuminates the figures from “0” to “9” or the arrow 40f to 46f (or the inscription “OK” for the key 62 referenced 62f) according to the actuation mode.

Thus the telephone 10 depicted in FIG. 3 functions according to the first mode of actuating the multifunction keys. Consequently only the figures from “0” to “9” on the keypad 24 are visible. The arrows 40f to 46f and the inscription OK 62f depicted in fine lines are not visible to the user.

On the other hand, the telephone 10 depicted in FIG. 4 functions according to the second mode of actuating the multifunction keys of the alphanumeric keypad 24. The even FIGS. 40c to 46c and the figure “5” 62c have disappeared; only the arrows 40f to 46f representing the direction of movement of the cursor 36 and the inscription OK 62f are visible.

The illumination of the FIGS. 40c to 46c and 62c or the arrows 40f to 46f of the inscription OK 62f on the multifunction keys 40 to 46, and depending on whether the first or second actuation mode is selected respectively, can be obtained by a polarized-light illumination device.

The description of this example will be given solely for the multifunction keys 40 to 46 of the star-shaped key 53. The illumination of the fifth multifunction key 62 is advantageously effected in a similar fashion.

The device for illuminating each key 40 to 46 then has two filters and two polarized light source sources each emitting in a perpendicular direction. The two filters are arranged alongside each other in a plane substantially parallel to the back of the key. The first filter allows the passage of the light emitted by the first source and filters the light emitted by the second. Conversely, the second filter allows the passage of the light emitted by the second source and filters the light emitted by the first.

Each key 40 to 46 has first and second films, each of which has a first and second transparent zone which represents a FIGS. 40c to 46c or an arrow 40f to 46f respectively.

The two films are arranged opposite the first and second filter respectively.

Thus, when the first dialing mode is selected, the first source emits a polarized light which passes through the first filter and the first transparent zone of the first film. The image of the figure depicted on the first film is then projected onto the back of the key, thus enabling the user to see the figure.

According to this first mode, the polarized light emitted by the first source is filtered, that is to say blocked, by the second filter preventing the light from passing through the second transparent zone depicting an arrow of the second film so that the arrow, which does not have the light passing through it, is not visible to the user.

When the second mode is selected the second source emits the polarized light and, in a similar fashion to the first mode, enables the user to see the arrow on the second film. A key of this type is described more particularly in detail in patent WO-A-98.01876.

This solution is advantageous. This is because the projection of the FIGS. 40c to 46c and of the arrow 40f to 46f of a multifunction key 40 to 46 can be effected in a single zone of the back of the corresponding key. The necessary size for allowing the display of the figure and of the arrow is reduced. This makes it possible, while keeping the same dimensions of the multifunction keys 40 to 46, to increase the size of the figures or arrows so as to increase their visibility.

Such an illumination device can also make it possible to reduce the dimensions of the keys 40 to 46. It is thus possible to reduce the dimensions of the keypad 24 and/or to increase the number of keys in order to facilitate the use of the functions of the telephone 10.

This makes it possible to use a key having a circular cross-section, the maximum dimensions of the figure and of the arrow being slightly less than the diameter of the corresponding key.

The polarized-light illumination device described above can be extended to other multifunction keys on the telephone in order to make it possible to reduce the dimensions of the telephone 10 still further.

The star-shaped key 53 is ergonomic. In addition, the use of the telephone 10 according to the invention, notably according to the third preferred embodiment, is intuitive. This is because, when the user holds the telephone 10 in one hand, he can dial a combination of figures and/or letters or navigate on the screen 32 and validate instructions by simple sliding movements of the thumb, on the same hand, on the star-shaped key 53 and the fifth multifunction key 62.

For example, when the telephone is functioning according to the second mode of actuating the multifunction keys and when the display screen 32 has a list of instructions I11, I12, I13, I21 . . . from which the user must select one, the cursor 36 can occupy as many positions as there are instructions.

Here the instructions I11, I12, I13, I21 . . . are arranged, in accordance with FIG. 4, in two columns of three instructions and the cursor 36 consists of a gray zone which is here on the instruction I12 situated at the second row of the first column.

If the user wishes to select the instruction, he merely has to actuate the fifth multifunction key 62.

If he wishes to select another instruction I12 he must move the cursor 36 by means of the multifunction keys 40 to 46 on the start-shaped key 53, and then validate his selection by actuating the fifth multifunction key 62.

The above description is not limitative. This is because it is possible to transpose the characteristics of one embodiment to another embodiment. For example, the polarized-light illumination device can be used in a similar fashion in the first or second embodiment.

1. A telephone (10), notably of the GSM type, which has a control device consisting notably of a keypad (24) with keys (22) able to move overall vertically in an independent fashion between an idle position and an actuation position, the individual actuation of which makes it possible to key in a combination of alphanumeric characters, notably a telephone number and a device for controlling the movement of a cursor (36), or the scrolling of a menu on a display screen (32),
characterized in that at least one of said dialing keys (22) is a multifunction key (40, 42, 44, 46) whose actuation according to a first mode makes it possible to dial, and whose actuation according to a second mode makes it possible to control the movement of the cursor (36).

2. A telephone (10) as claimed in the preceding claim, characterized in that the keypad has at least one pair of associated multifunction keys (40, 42) which makes it possible to control, respectively in two opposite directions, the movement of the cursor (36) along an axis substantially parallel to that of the alignment of the two keys (40, 42) in this pair.

3. A telephone (10) as claimed in the preceding claim, characterized in that the keypad has two pairs of associated multifunction keys which are arranged so that the direction of alignment of the two keys (40, 42) in the first pair is substantially at right angles to the direction of alignment of the two keys (44, 46) in the second pair.

4. A telephone (10) as claimed in the preceding claim, characterized in that the four multifunction keys (40, 42, 44, 46) in the two pairs are keys for dialing even digits on a standard 10-digit dialing keypad (24).

5. A telephone (10) as claimed in one of claim 3 or 4, characterized in that the four multifunction keys (40, 42, 44, 46) in the two pairs are connected together so as to form a star (53) with four arms (50, 52, 58, 60), each end of which constitutes a key (40, 42, 44, 46).

6. A telephone (10) as claimed in any one of claims 3 to 5, characterized in that the keypad (24) has at least a fifth multifunction key (62) whose actuation according to a first mode makes it possible to dial, and whose actuation according to a second mode makes it possible to demand the validation of an instruction.

7. A telephone (10) as claimed in the preceding claim, characterized in that the fifth key (62) is arranged substantially at the intersection of the axes of the alignments of the two pairs of keys (40, 42, 44, 46).

8. A telephone (10) as claimed in the preceding claim taken in combination with claim 4, characterized in that the center of the star (53) has a central hole (56) for the fifth key (62) to pass with a view to allowing the independent actuation of the star (53) and the fifth key (62).

9. A telephone (10) as claimed in any one of the preceding claims, characterized in that the telephone has means of controlling the simultaneous switching of the change in actuation mode of said multifunction keys.

10. A telephone (10) as claimed in the preceding claim, characterized in that the means of controlling the switching from one mode to another consist of the recognition of a predetermined voice message by the control device.

11. A telephone (10) as claimed in claim 8, characterized in that the means of controlling the switching from one mode to another consist of the holding in the actuation position of a key (22) on the control keypad (24) for a period greater than a predetermined period.

12. A telephone (10) as claimed in claim 8, characterized in that the means of controlling the switching from one mode to another consist of the actuation of certain keys (22) on the keypad (24) in a predetermined order.

13. A telephone (10) as claimed in claim 8, characterized in that the means of controlling the switching from one mode to another consist of the actuation of a specific key (22) on the keypad (24).

14. Apparatus, which has a control device consisting notably of a keypad (24) with keys (22) able to move overall vertically in an independent fashion between an idle position and an actuation position, the individual actuation of which makes it possible to key in a combination of alphanumeric characters, notably a telephone number and a device for controlling the movement of a cursor (36), or the scrolling of a menu on a display screen (32).
